(19) United States
(12) Patent Application Publication
(10) Pub. No.: US 2026/0116479 A1
(43) Pub. Date: Apr. 30, 2026

(54) DRAG REDUCTION TONNEAU SYSTEM

(71) Applicant: FCA US LLC, Auburn Hills, MI (US)

(72) Inventors: Mark C Trostle, Auburn Hills, MI (US); Anthony L Vincent, Auburn Hills, MI (US); Mark J Coletti, Auburn Hills, MI (US); Rimon I Ghobrial, Auburn Hills, MI (US); Jeffrey R Aneiros, Auburn Hills, MI (US); Nicholas Vardis, Auburn Hills, MI (US); Rajan Alagarsamy, Auburn Hills, MI (US)

(21) Appl. No.: 18/932,881

(22) Filed: Oct. 31, 2024

(51) Int. Cl. B62D 35/00; B60J 7/04; B60J 7/057

(52) U.S. Cl. CPC B62D 35/007; B60J 7/041; B60J 7/057

(57) ABSTRACT

A tonneau system for a vehicle including a cargo bed comprises a frame including a leading edge and a trailing edge. A cover is coupled to the frame and movable between a deployed position and a retracted position. A mechanism is coupled to the frame and operable to move the frame and the cover between a home position, an aerodynamic position, and an extended box position. When at the home position, the frame extends substantially parallel to the ground at a first elevation. The leading edge of the frame is positioned at a second elevation higher than the first elevation and the trailing edge remains at the first elevation when the frame is at the aerodynamic position. The leading edge and the trailing edge of the frame are positioned at the second elevation when at the extended box position.

### FIELD

The present disclosure relates to an articulatable tonneau system for a vehicle. The tonneau system may be moved between a number of positions including an aerodynamic drag reducing position.

### BACKGROUND

This section provides background information related to the present disclosure which is not necessarily prior art.

An ongoing challenge exists to increase the operating efficiency of motor vehicles. While great strides have been made in increasing the aerodynamic efficiency of passenger cars, certain vehicles, such as pickup trucks and other vehicles having a cargo bed are significantly less aerodynamically efficient due to the upright position of the tailgate at the end of the vehicle cargo bed.

In the past, some pickup trucks have been equipped with tonneau covers that extend across an upper surface of the truck bed walls and the tailgate to enclose the cargo bed and define a storage compartment. While some of these designs have increased the aerodynamic efficiency of the vehicle, their functionality is limited based on the structure of the system. Some known designs include a fixed cap or manually foldable panels arranged in a trifold configuration.

While these designs have served their purpose, there is a need in the art for a tonneau system operable in several different positions based on an operator's need. For example, it may be desirable to provide a tonneau system having a minimal cross-sectional profile at a home position, an aerodynamically efficient sloped position, and a fully expanded box position to achieve maximum storage volume.

### SUMMARY

This section provides a general summary of the disclosure and is not a comprehensive disclosure of its full scope or all of its features.

A tonneau system for a vehicle including a cargo bed comprises a frame including a leading edge and a trailing edge. A cover is coupled to the frame and movable between a deployed position and a retracted position. A mechanism is coupled to the frame and operable to move the frame and the cover between a home position, an aerodynamic position, and an extended box position. When at the home position, the frame extends substantially parallel to the ground at a first elevation. The leading edge of the frame is positioned at a second elevation higher than the first elevation and the trailing edge remains at the first elevation when the frame is at the aerodynamic position. The leading edge and the trailing edge of the frame are positioned at the second elevation when at the extended box position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary perspective view of an exemplary vehicle equipped with a tonneau system constructed in accordance with the teachings of the present disclosure;

FIG. 2 is a perspective view of the tonneau system shown in a home position;

FIG. 3 is a perspective view of the tonneau system shown in an aerodynamic position;

FIG. 4 is a perspective view of the tonneau system shown in an extended box position;

FIG. 5 is a fragmentary perspective view of the tonneau system including first and second side panels in deployed positions while the frame is at the aerodynamic position; and

FIG. 6 is a fragmentary perspective view depicting the tonneau system including first through fourth side panels positioned in deployed positions with the frame disposed at the extended box position.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

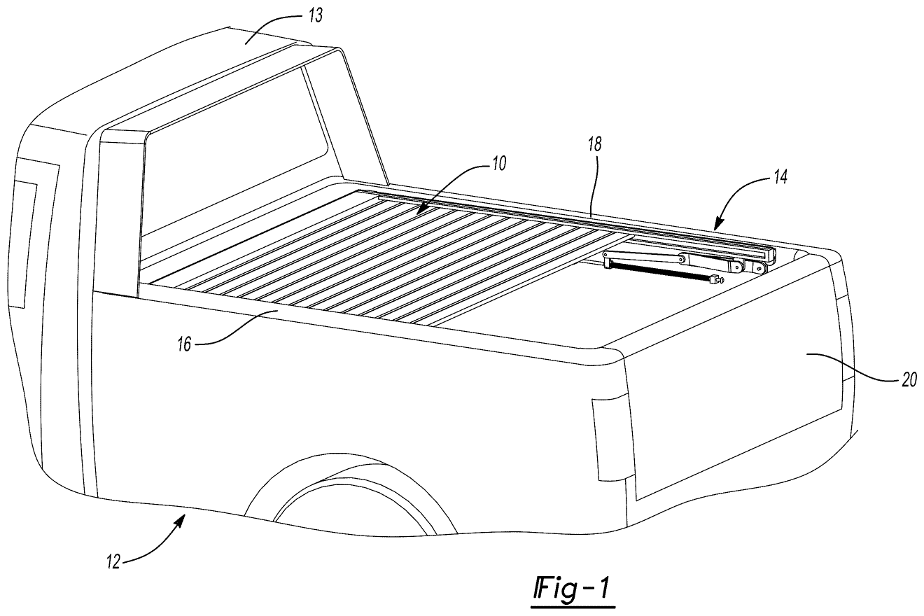

With reference to FIGS. 1-6, a tonneau system 10 is shown coupled to an exemplary vehicle 12. Vehicle 12 includes a cab 13 as well as a cargo bed 14 including side walls 16, 18 and a tailgate assembly at reference numeral 20.

Tonneau system 10 includes a frame 22 including a header 24, a first rail 26, and a second rail 28. Frame 22 is sized and shaped to correspond to the size and shape of cargo bed 14. First rail 26 is positioned adjacent to side wall 16. Second rail 28 is positioned adjacent to side wall 18. Header 24 is positioned at a leading edge 31 of tonneau system 10 proximate to cab 13. Tonneau system 10 may include an optional hoop 30 coupled to cab 13. Hoop 30 may be coupled to side walls 16, 18. Hoop may represent a variety of different structures including a light bar or an accessory bar.

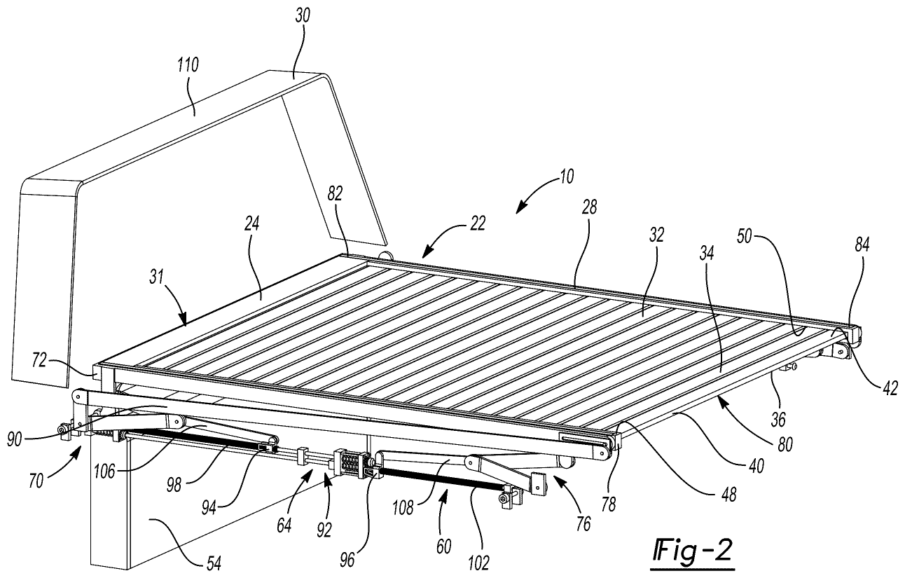

Tonneau system 10 includes a retractable cover 32 slidingly coupled to frame 22. It is envisioned that cover 32 may be constructed using a variety of different components. In a first arrangement, cover 32 includes a plurality of transversely extending slats 34. Slats 34 are positioned adjacent to one another and coupled to a membrane or backing panel 36. FIGS. 1 and 2 depict cover 32 in a deployed positioned enclosing cargo bed 14. Each of slats 34 includes a first end 40 and an opposite second end 42. Each first end 40 of each slat 34 is positioned within a groove 48 formed on first rail 26. Similarly, each second end 42 of each slat 34 is positioned within a groove 50 of second rail 28. Grooves 48, 50 act as guides defining the position of slats 34.

In an alternate arrangement cover 32 is constructed one-piece monolith member including a plurality of slats 34 interconnected by a relatively thin web of material. The relatively thin web of material acts as a living hinge allowing the cover to move between the deployed and retracted positions.

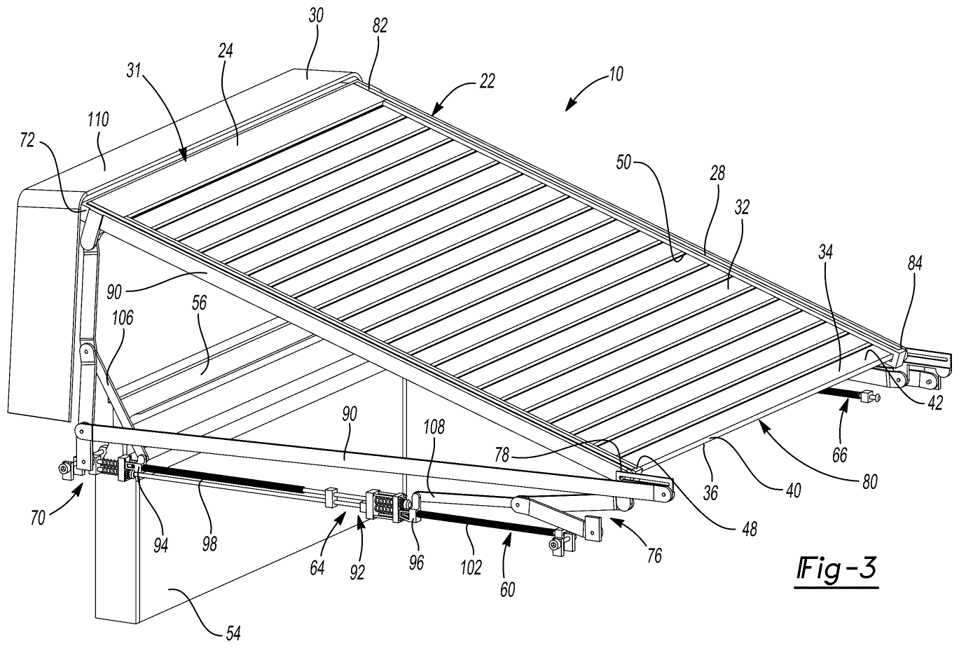

Tonneau system 10 includes a cartridge 54 coupled to vehicle 12. Cartridge 54 is shaped as a hollow housing having an open end 56 as depicted in FIG. 3. Cover 32 is moveable between the deployed position in FIG. 2 and a retracted position where a majority if not all of slats 36 are positioned within cartridge 54. In the retracted position, cover 32 may be rolled in a spiral shape or slats 36 may be positioned within cartridge 54 in a stacked arrangement. FIG. 1 depicts cover 32 in an intermediate position between the retracted and deployed positions.

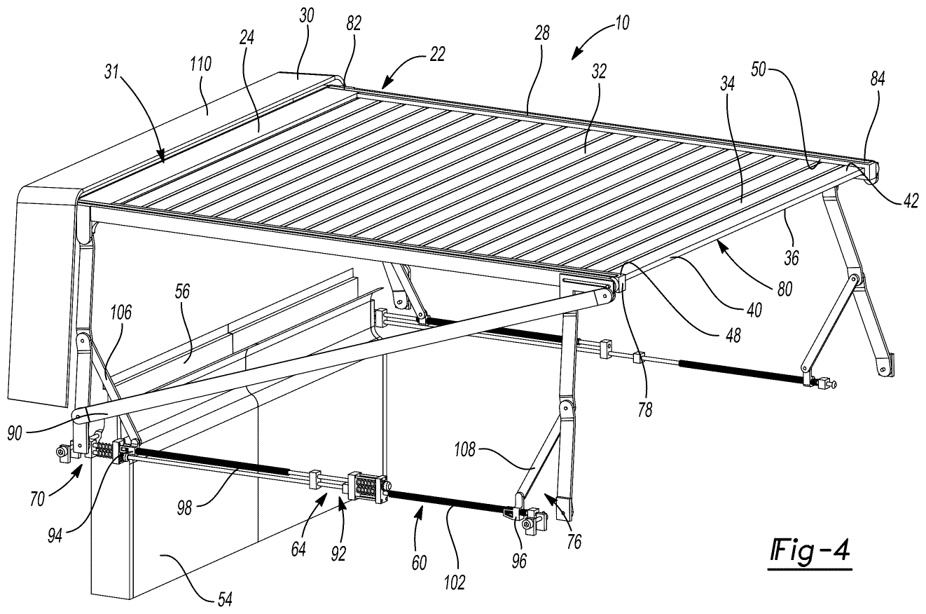

A drive mechanism 60 movably interconnects frame 22 with vehicle 12. Drive mechanism 60 is operable to move frame 22 and cover 32 between a home position depicted in FIG. 2, and aerodynamic position depicted in FIG. 3, and an extended box position as depicted in FIG. 4. Drive mechanism 60 incudes a first subsystem 64 and a second subsystem 66. First subsystem 64 is coupled to first rail 26. Second subsystem 66 is coupled to second rail 28. First subsystem 64 is substantially the same as second subsystem 66. Accordingly, only first subsystem 64 will be described in detail.

First subsystem 64 includes a first linkage 70 coupled to a first end 72 of first rail 26. First subsystem 64 further includes a second linkage 76 coupled to an opposite second end 78 of first rail 26. Second end 78 is at a trailing edge 80 of frame 22. First linkage 70 is operable to move first end 72 of first rail 26 as well as header 24 and a first end 82 of second rail 28 between a lowered positioned depicted in FIG. 2 and a raised positioned depicted FIGS. 3 and 4. Second linkage 76 is similarly operable to move second end 78 of first rail 26 and a second end 84 of second rail 28 between a lowered positioned depicted in FIGS. 2 and 3 and a raised positioned shown in FIG. 4. A support 90 interconnects first linkage 70 with second linkage 76.

First subsystem 64 includes a linear actuator 92 operable to translate a first coupling 94 between a first positioned depicted in FIG. 2 and a second positioned depicted in FIG. 3. Linear actuator 92 is also operable to independently translate a second coupling 96 between a first position shown in FIGS. 2 and 3 and a second position shown in FIG. 4. In one configuration, linear actuator 92 may include a first ball screw 98 drivingly engaged with first coupling 94. Rotation of first ball screw 98 causes first coupling 94 to linearly translate in a direction based on the rotation direction of first ball screw 98. A second ball screw 102 drivingly engages second coupling 96 such that rotation of second ball screw 102 causes linear translation of second coupling 96. It should be appreciated that linear actuator 92 may be manually operated or may be configured in association with an electric or hydraulic motor operable to rotate first ball screw 98 and second ball screw 102.

First linkage 70 includes a first drive link 106 coupled to first coupling 94. Second linkage 76 includes a second drive link 108 drivingly coupled to second coupling 96. As depicted in the Figures, selective movement of either or both first coupling 94 and second coupling 96 causes frame 22 and cover 32 to be positioned in one of the three positions previously described and depicted in FIGS. 2, 3 and 4.

To locate frame 22 and cover 32 in the home position shown in FIG. 2, first coupling 94 and second coupling 96 are driven to locations closest to one another. At the home position, frame 22 and cover 32 extend substantially parallel to the ground at a base elevation that is as close to ground as possible. Stated another way, when frame 22 and cover 32 are at the home position, they extend on substantially the same plane as uppermost portions of first and second side walls 16, 18. This position may also be considered as a flat position.

Frame 22 and cover 32 may be selectively moved to the aerodynamic position shown in FIG. 3 by maintaining the same position of second coupling 96 as earlier and actuating linear actuator 92 to move first coupling 94 to a position furthest from second coupling 96. Once at the aerodynamic position, first end 72 of first rail 26, first end 82 of second rail 28, and header 24 are located at a raised elevation relative to the base position at substantially the same elevation as a cross bar 110 of hoop 30. Leading edge 31 is positioned adjacent to hoop 30 to provide an aesthetically pleasing and substantially sealed configuration.

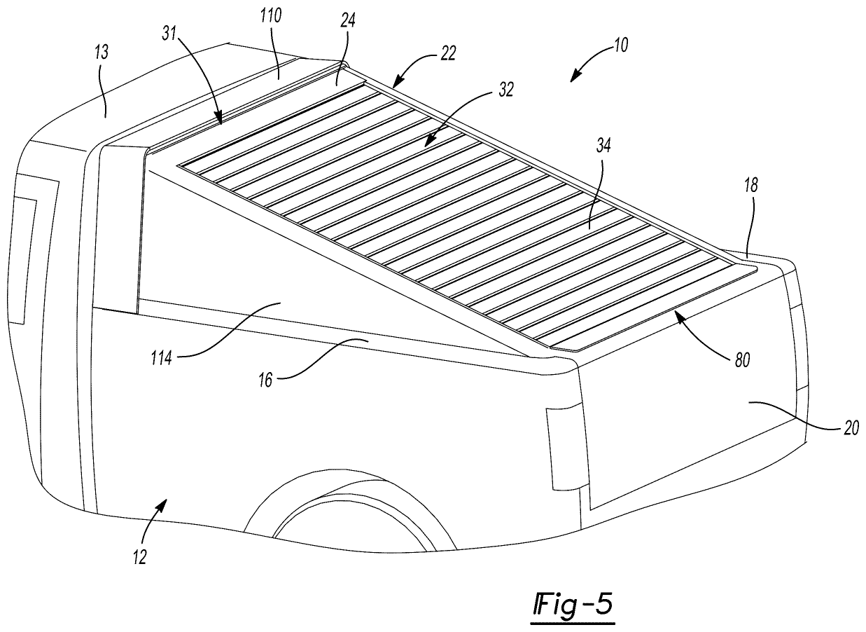

After moving frame 22 and cover 32 from the home position to the aerodynamic position, it may be desirable to enclose the triangularly shaped gaps between the side walls 16, 18 and frame 22. As best shown in FIG. 5, tonneau system 10 includes a first moveable side panel 114 and an opposed second moveable side panel (not shown). First moveable side panel 114 may be coupled to first rail 26 or may be coupled vehicle 12 and separately deployable between retracted and extended positions.

Tonneau system 10 is also operable in the extended box position. When tonneau system 10 is at the extended box position shown in FIG. 4, slats 34 as well as first rail 26 and second rail 28 are substantially parallel to the ground such that first end 72 of first rail 26 is at substantially the same elevation as second end 78 of first rail 26. First end 82 and second end 84 of second rail 28 are also at the elevated position. To achieve the extended box position, linear actuator 92 drives first coupling 94 and second coupling 96 to positions as far away from each other as possible.

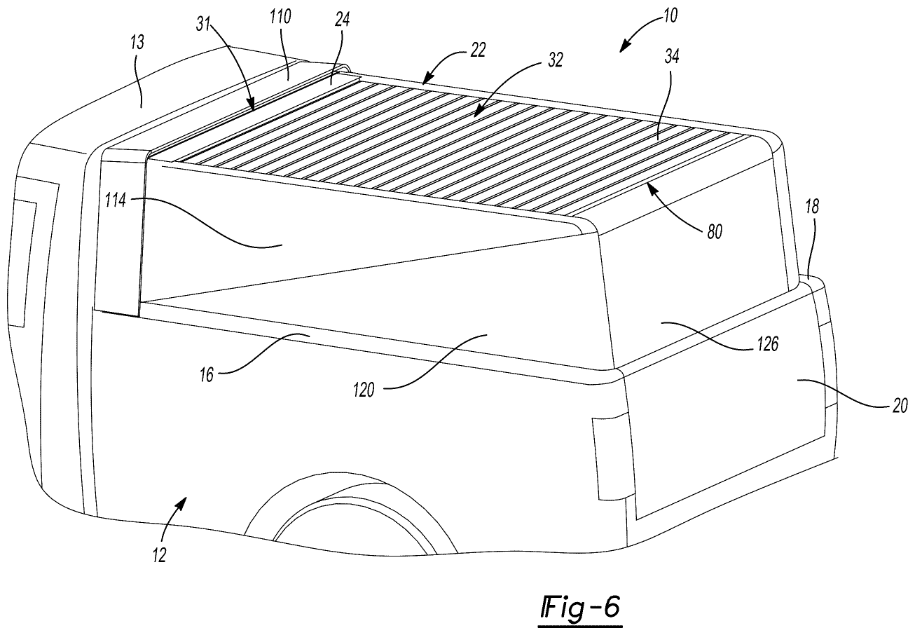

As shown in FIG. 6, tonneau system 10 may include a third side panel 120 and a fourth side panel (not shown). Third side panel 120 and the fourth side panel may be located at deployed positions when tonneau system 10 is at the extended box positioned as depicted in FIG. 4. Third panel 120 may be coupled first panel 114 or may be coupled to vehicle 12 and separately deployable relative to first rail 26. Similarly, the fourth panel may be coupled to the second panel or may be separate and individually deployable relative to second rail 28. Tonneau system 10 also includes a rear panel 126 movable between an open position and a closed position when operating in the extended box configuration.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tonneau system for a vehicle including a cargo bed, comprising:
a frame including a leading edge and a trailing edge;
a cover coupled to the frame and moveable between a deployed position and a retracted position; and
a mechanism coupled to the frame and operable to move the frame and the cover between a home position, an aerodynamic position and an extended box position, wherein at the home position, the frame extends substantially parallel to the ground at a first elevation, wherein the leading edge of the frame is positioned a second elevation higher than the first elevation and the trailing edge remains at the first elevation when the frame is at the aerodynamic position, and wherein the leading edge and the trailing edge of the frame are positioned at the second elevation when at the extended box position.

2. The tonneau system of claim 1, further comprising a drive system operable to move the leading edge and the trailing edge of the frame between the first elevation and the second elevation.

3. The tonneau system of claim 2, wherein the mechanism includes a first subsystem associated with a first rail of the frame and a second subsystem associated with an opposite second rail of the frame.

4. The tonneau system of claim 3, wherein the first subsystem includes a first linkage for moving the leading edge of the frame between the first elevation and the second elevation as well as a second linkage operable for moving the trailing edge of the frame between the first elevation and second elevation.

5. The tonneau system of claim 4, wherein the first subsystem includes a first linear actuator drivingly coupled to the first linkage and a second linear actuator drivingly coupled to the second linkage.

6. The tonneau system of claim 5, wherein the first linear actuator includes a ball screw drivingly engaged with a coupling, wherein the coupling is coupled to the first linkage.

7. The tonneau system of claim 1, wherein the cover includes a plurality of transversely extending slats coupled to the frame.

8. The tonneau system of claim 7, further comprising a cartridge in receipt of a majority of the cover when the cover is in the retracted position.

9. The tonneau system of claim 1, further comprising first and second side panels moveable between retracted and deployed positions, wherein the first and second side panels are at the retracted positions when the frame is at the home position, wherein the side panels are movable to the deployed positions when the frame is at the aerodynamic position.

10. The tonneau system of claim 9, further comprising third and fourth side panels moveable between retracted and deployed positions, wherein the third and fourth panels are at the retracted positions when the frame is at either of the home or aerodynamic positions, wherein the third and fourth side panels are movable to their deployed positions when the frame is at the extended box position.

11. A tonneau system for a vehicle including a cargo bed, comprising:
a frame including a leading edge and a trailing edge;
a segmented cover coupled to the frame, the cover being moveable between a deployed position and a retracted position, the cover extending along a plane when in the deployed position and being compacted when in the retracted position; and
a mechanism coupled to the frame and operable to move the frame between a home position, an aerodynamic position and an extended box position, wherein at the home position, the frame extends substantially parallel to the ground at a first elevation, wherein the leading edge of the frame is positioned a second elevation higher than the first elevation and the trailing edge remains at the first elevation when the frame is at the aerodynamic position, and wherein the leading edge and the trailing edge of the frame are positioned at the second elevation when at the extended box position.

12. The tonneau system of claim 11, further comprising a drive system operable to move the leading edge and the trailing edge of the frame between the first elevation and the second elevation.

13. The tonneau system of claim 12, wherein the mechanism includes a first subsystem associated with a first rail of the frame and a second subsystem associated with an opposite second rail of the frame.

14. The tonneau system of claim 13, wherein the first subsystem includes a first linkage for moving the leading edge of the frame between the first elevation and the second elevation as well as a second linkage operable for moving the trailing edge of the frame between the first elevation and second elevation.

15. The tonneau system of claim 14, wherein the first subsystem includes a first linear actuator drivingly coupled to the first linkage and a second linear actuator drivingly coupled to the second linkage.

16. The tonneau system of claim 15, wherein the first linear actuator includes a ball screw drivingly engaged with a coupling, wherein the coupling is coupled to the first linkage.

17. The tonneau system of claim 11, wherein the cover includes a plurality of transversely extending slats coupled to the frame.

18. The tonneau system of claim 17, further comprising a cartridge in receipt of a majority of the cover when the cover is in the retracted position.

19. The tonneau system of claim 11, further comprising first and second side panels moveable between retracted and deployed positions, wherein the first and second side panels are at the retracted positions when the frame is at the home position, wherein the side panels are movable to the deployed positions when the frame is at the aerodynamic position.

20. The tonneau system of claim 19, further comprising third and fourth side panels moveable between retracted and deployed positions, wherein the third and fourth panels are at the retracted positions when the frame is at either of the home or aerodynamic positions, wherein the third and fourth side panels are movable to their deployed positions when the frame is at the extended box position.
